(19) United States
(12) Patent Application Publication
(10) Pub. No.: US 2007/0149063 A1
(43) Pub. Date: Jun. 28, 2007

(54) TAPERED DROP BOX

(76) Inventor: Craig Thomas, Stevensville, MT (US)

Correspondence Address: KLARQUIST SPARKMAN, LLP, 121 SW SALMON STREET, SUITE 1600, PORTLAND, OR, 97204, US

(21) Appl. No.: 11/612,338

(22) Filed: Dec. 18, 2006

Related U.S. Application Data
(60) Provisional application No. 60/753,063, filed on Dec. 21, 2005.

(51) Int. Cl. H01R 13/502

(52) U.S. Cl. 439/687

(57) ABSTRACT

One embodiment of the disclosed drop box comprises end wall portions that taper from a first end to a second end, such as being wider adjacent to an open top portion and narrower adjacent to a bottom wall. The end walls are coupled to the bottom wall, which also tapers from a first end to a second end, such as tapering from a wide end adjacent to a front end wall to a narrower end adjacent to a back end wall. The drop box thus can have a taper in a first direction and a taper in a second direction. These tapers in the first and second directions can be sized and shaped as desired and to allow a first drop box to be nested with a second drop box, such as for transport or storage.

### CROSS REFERENCE TO RELATED APPLICATION

This application claims the benefit of the earlier filing date of U.S. patent application Ser. No. 60/753,063, entitled Tapered Drop Box, which was filed Dec. 21, 2005, and is incorporated herein by reference.

### FIELD

Disclosed embodiments concern material containers, such as a drop box, and even more particularly a drop box that can be nested with similar drop boxes for transportation.

### BACKGROUND

Dispensing and/or storage bins, commonly referred to as drop boxes, drop containers, or similar terms, are known and are routinely used for receiving and/or transporting a variety of materials, such as construction material refuse. Many drop boxes have been patented including, for example, U.S. Pat. No. 6,416,271, which describes a drop box container for bottom release of contained bulk material.

A common problem associated with all such devices is transportation to and from remote sites. For example, slash material produced during a logging operation might need to be removed from a work area remote from more inhabited areas where the drop boxes are stored. Typically a single drop box is transported per trip by truck from the storage location to the remote location, dropped off for receiving desired material, and then transported back to a material disposal or processing site.

### SUMMARY

Some disclosed drop box embodiments are shaped so as to be nested together in a stack. This has many advantages, including facilitating transport from a first location to a second location. Some of these disclosed embodiments comprise end wall portions that taper from a first end to a second end. For example, the width of these end wall portions adjacent to an open top portion of the drop box can be greater than their width adjacent to a bottom wall, The end walls can be coupled to the bottom wall, which also can taper from a first end to a second end, such as tapering from a wide end adjacent a front end wall to a narrower end adjacent a back end wall. The drop box thus can have a taper in a first direction and a taper in a second direction. These tapers in the first and second directions can be sized and shaped to allow a first drop box to be nested with a second drop box, such as for transport or storage.

Certain disclosed embodiments also include at least one crease in at least one wall, such as a side wail, The crease, or creases, can extend along a substantial portion of at least one dimension of the drop box, such as from a front end wall to a back end wall.

The disclosed drop boxes can include an openable end, openable ends, and/or an open or openable top or bottom to facilitate loading or unloading material. The openable end or ends can include at least one door, or can include plural doors, or can include at least one door per each end of the drop box. The door, or doors, can be securely but removably coupled to an end, such as by using a lever actuated assembly.

The disclosed drop boxes can be made from any suitable material. Exemplary materials include metals, metal alloys, polymers, wood, and combinations thereof.

One particular embodiment of a disclosed metal or metal alloy drop box comprises plural end panels, at least one of which is openable. The drop box tapers from a first end adjacent to an open or openable top to a second end. An openable end of the drop box includes a door and typically includes plural doors that are securely but removably coupled to the end portion by a lever actuated assembly. The side wall includes at least one crease and more typically plural such creases which extend along at least a substantial portion of a side wall dimension, such as extending substantially the entire length of the drop box side wall. The drop box also can include a bottom panel that tapers from the first openable end to a second hack wall. The assembled drop box therefore can have a first taper and a second taper.

The drop boxes can be stacked to provide a combination of drop boxes. The combination can comprise a first drop box and at least a second drop box nested with the first drop box. Generally, at least one of the first and second drop boxes is tapered in two dimensions and more typically both the first and second drop boxes are tapered in two dimensions. In some embodiments the first drop box is configured to be nested within the second drop box such that the first drop box extends through an open front end of the second drop box, the second drop box having a front end door configured to be secured in an open position. The front end door of the second drop box can be configured to swing about 270° between a closed position and the open position.

A method for transporting drop boxes also is disclosed, The method can comprise providing a first drop box that is tapered in at least two dimensions, providing a second drop box that is tapered in at least two dimensions, and stacking the first drop box with the second drop box to provide a nested combination,

Finally, a method for making drop boxes is disclosed. One embodiment of the method comprises providing or forming at least one end panel that tapers from a wide end to a second narrower end. A bottom wall also can be provided or formed that tapers from a first wide end to a second narrower end. The drop box then can be assembled by coupling the end panel or panels to the bottom wall.

The foregoing and other objects, features, and advantages of the invention will become more apparent from the following detailed description, which proceeds with reference to the accompanying figures.

### BRIEF DESCRIPTION OF THE DRAWINGS

FIG. 1 is a perspective view illustrating an embodiment of an assembled drop box.

FIG. 2 is a perspective view of an embodiment of an assembled drop box.

FIG. 3 is a perspective view illustrating an assembled drop box embodiment having ends that taper outwardly from bottom wall to drop box opening, and further illustrating one method for loading or unloading the drop box.

FIG. 4 is a plan view of plural nested drop boxes.

FIG. 5 is a cross-sectional view along line 5-5 illustrating tapering of the drop box outwardly from first bottom wall portion to a second portion adjacent a top wall portion.

### DETAILED DESCRIPTION

I. Definitions

The following explanations of terms and methods are provided to better describe the present disclosure and to guide those of ordinary skill in the art in the practice of the S present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means including A, B, or A and B,“without excluding additional elements.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting.

II. Description of Disclosed Embodiments with Reference to Drawings

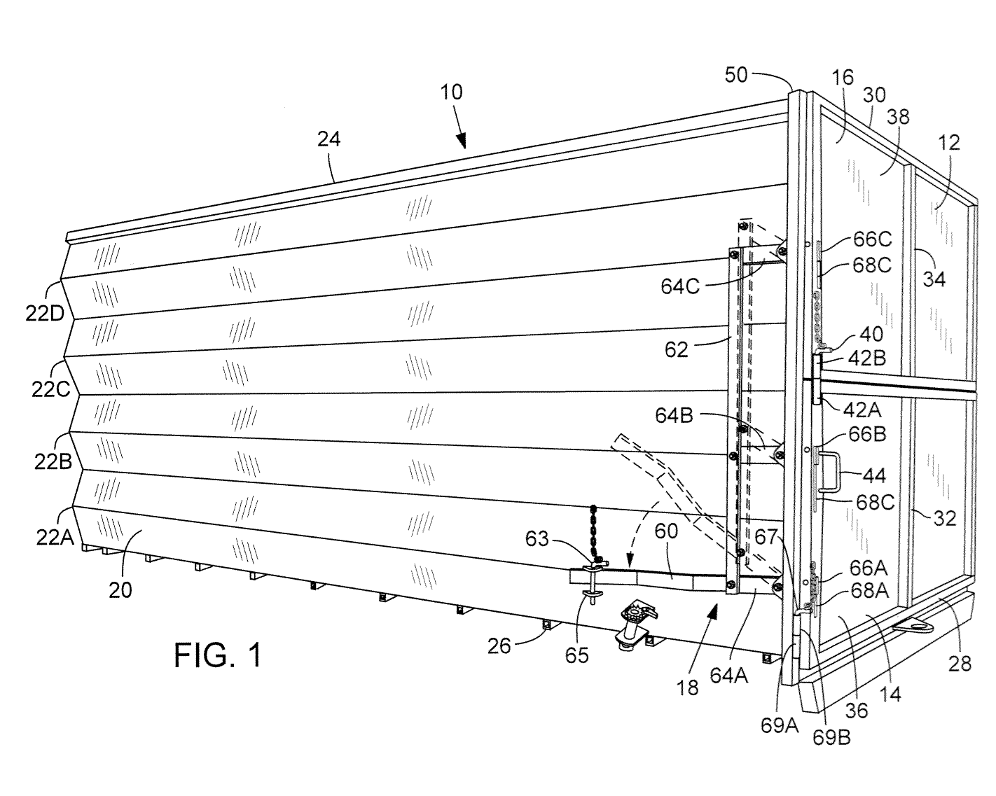

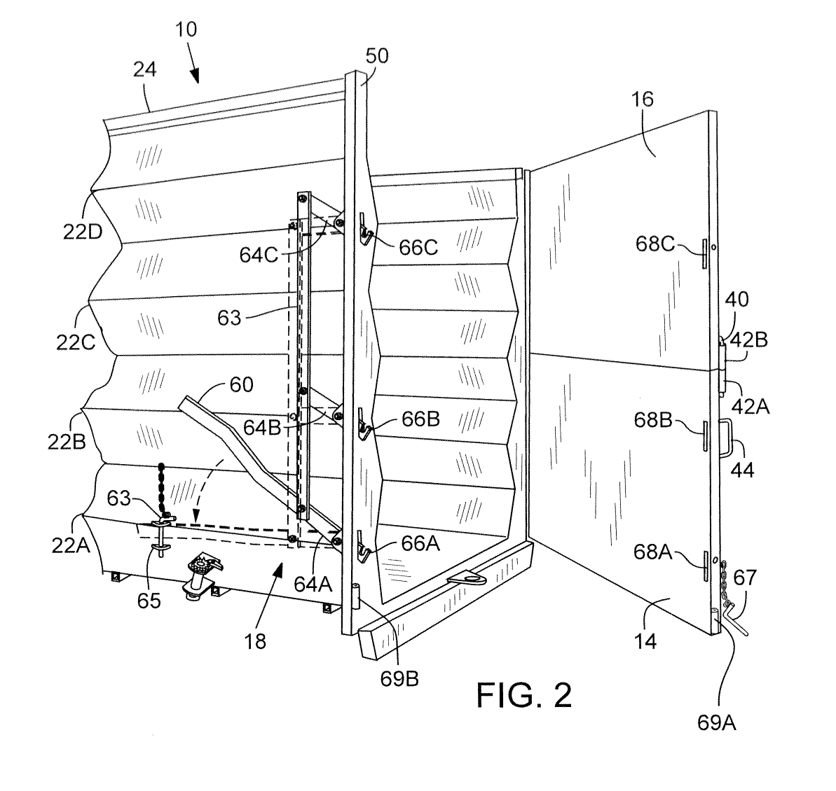

FIG. 1 illustrates a perspective view of an assembled embodiment of a drop box 10 having a dump or load end 12. Various opening and/or door designs can be used to facilitate loading or unloading contained material. The embodiment illustrated by FIG. 1, provided to exemplify disclosed drop boxes, includes two door portions 14 and 16. Door portions 14 and 16 are securely coupled to drop box 10 using assembly 18, which is further described with referenced to FIG. 2.

FIG. 1 illustrates a side wall portion 20 having at least one, and typically plural, longitudinally extending crease or creases 22A-D. Crease or creases 22 add substantial strength to the wall while simultaneously minimizing the necessary amount of material, or the necessary strength of the material (e.g., metal gauge). Thus, crease or creases 22 enhance utility and reduce production costs. A variety of forming process can be used to make wall 22 and other drop box components, such as press forming. Wall 20 also can be assembled from various components. Drop box 10 also includes a top frame portion 24 and plural transverse bottom support brackets 26.

Doors 14 and 16 can be of substantially identical design, shape, and/or dimensions. Alternatively, doors 14 and 16 can have different designs, shapes, dimensions, etc. Illustrated drop box 10 includes frame members 28 and 30, with cross members 32 and 34, respectively. Panels 36 and 38 are coupled to frame members 28 and 30 by any suitable means, such as welding or fasteners, to define doors 14 and 16. Top door portion 16 can be coupled to bottom door 14, such as to preclude opening during transport, using any suitable mechanism. FIG. 1 illustrates a pin 40 adapted to be received in portions 42A and 42B for coupling door portions 14 and 16. Door portion 14 or 16 also optionally can include a handle 44 to assist opening. Disclosed embodiments of drop box 10 can have no doors (top loading, for example), can include one or more doors at a first end of drop box 10, can include one or more doors at a second end of drop box 10, can include one or more doors at both ends of drop box 10, can include one or more doors in a side wall, such as wall 20, and all combinations thereof.

Assembly 18 illustrated by FIG, 1 and FIG. 2 includes an embodiment of a mechanism to further secure doors 14 and 16 to door frame 50. Assembly 18 includes handle 60 rotatably coupled to pivot arm 62 and at least one and typically plural arms 64A-C. Arm(s) 64 include engaging teeth 66 (FIG. 2) that are received in slots 68 of door portions 14 and 16, respectively. By actuating lever assembly 18 door engaging teeth 66 effectively securely couple door portions 14 and 16 to drop box 10. Handle 60 can be secured, if necessary. The illustrated embodiment secures handle 60 to wall 20 using a handle bracket comprising pin 63 and pin receiving brackets 65. As shown in FIG. 1 and FIG. 2, the doors 14 and 16 similarly are secured to the door frame 50 by a pin 67 that slides into receiving portions 69A and 69B affixed to the door 14 and the door frame 50, respectively.

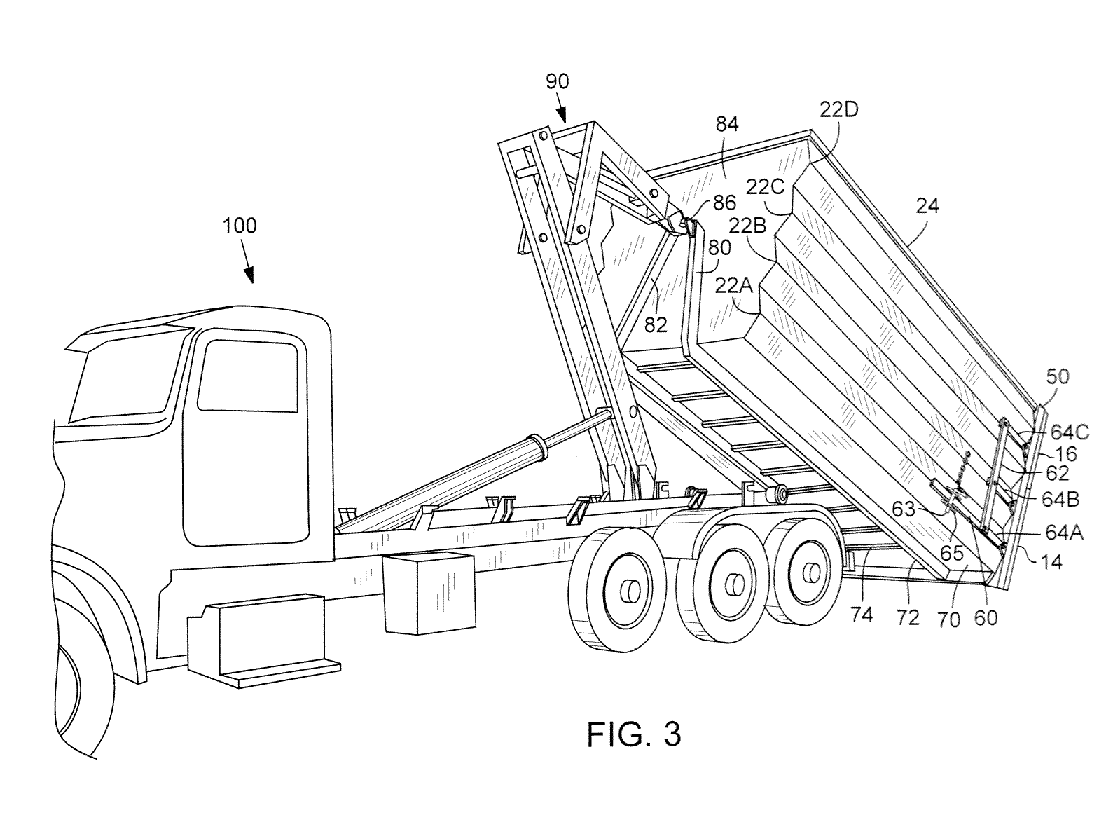

FIG. 3 provides a view of a bottom wall 70 having bottom bracket 72 and cross members 74. FIG. 3 also illustrates a bracket assembly having first and second brackets 80 and 82 coupled by any effective means, such as welding, to end panel 84. Bracket assembly 80 also includes a hoist or lift receiving bracket 86 for receiving a hoist 90 of a transport truck 100.

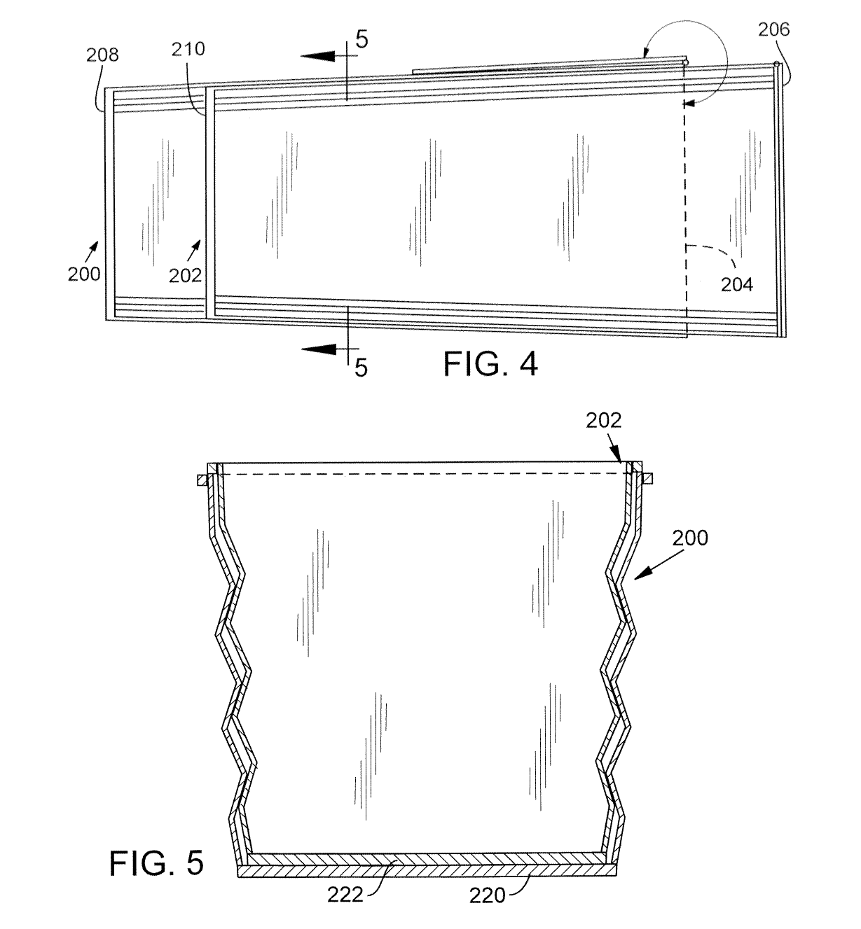

FIG. 4 is a top plan view of nested drop boxes 200 and 202. Drop boxes 200 and 202 each have a door end 204, 206, respectively, that is wider than back end panels 208, 210. Bottom wall panels 220, 222 (FIG. 5) have a first end adjacent door ends 204, 206 and a second end adjacent hack end panels 208, 21 0. In certain embodiments, bottom walls 220, 222 taper from the first end to the second end. Again, a person of ordinary skill in the art will realize that the degree of taper is variable. However, solely to illustrate the degree of taper in a working embodiment, a first end of a bottom wall had a span of approximately 95 inches and the second end had a span of approximately 84 inches.

FIGS. 3, 4 and 5 illustrate that certain embodiments of the drop box 10 are tapered in two dimensions. As best illustrated in FIGS. 3 and 5, drop box 10 has two sets of first and second ends. For example, the drop box 10 can have a front end and a back end as well as a top end and a bottom end. Similar to the front end and the back end described above, the drop box 10 can have a first span at a top end and a second span at a bottom end that is less than the first span. As a result, drop box 10 can taper from a first top end to a narrower bottom end. A person of ordinary skill in the art will appreciate that the degree of taper is variable. Solely for purpose of illustration, a working embodiment of drop box 10 with door frame 50 had a side wall span that was substantially constant from a top end to a bottom end, and a front and back wall span that was wider adjacent to the top end and narrower adjacent to the bottom end. For example, in a working embodiment, the back wall span adjacent to the top end was about 117 inches, and the back wall span adjacent to the bottom end was about 107 inches.

Thus, in some embodiments, a rectangular drop box 10 tapers in a first direction that extends along a short axis from a first end to a second end, and also has a taper in a second direction that extends along a long axis from a first end to a second end. By including such tapers, plural drop boxes 10 can be nested one with another for transport.

III. Materials and Assembly

Various materials, gauges of materials, panel or frame dimensions, etc., can be used to construct working embodiments. Exemplary useful materials for constructing disclosed drop boxes include metals, metal alloys, polymers, wood, etc. Combinations of these materials also can be used. Particular examples of metals and metal alloys include, without limitation, iron, aluminum, and iron and aluminum alloys. Working embodiments typically were made from metal. Material choice may be dictated, at least in part, by end-use applications and the strength, weight and durability required to satisfy end-use applications.

Components, such as doors 14 and 16, can have a substantially unitary construction, for example, if press formed, or may have various components coupled together. Assembly can include permanent joining techniques, such as welding, non-permanent joining techniques, exemplified by use of fasteners, such as bolts, washers, screws, and combinations of such techniques and parts.

IV. Applications

Embodiments of the disclosed drop box can be used for a variety of applications. In some embodiments, two or more nested drop boxes are transported from a first location to a second location by a conventional transportation method, such as by truck. Once the drop boxes reach the second location, they can be unloaded, for example, by removing the drop boxes in order from the innermost nested drop box to the outermost nested drop box. In some embodiments, the innermost nested drop box is removed at the second location and then the remaining drop box or boxes are transported to a third location where the next innermost drop box is removed. In this way, multiple drop boxes can be delivered to one or more locations without the need for multiple trips to a drop box storage area.

In some embodiments, the drop boxes have front walls that are either removable or hinged such that they can be folded back against the side wall and secured (FIG. 4). When nested with other drop boxes, the front walls can be removed or folded back to leave the front ends open. For example, an inner drop box can be held within an outer drop box such that it extends through the open front end of the outer drop box, as shown in FIG. 4 In this configuration, the drop boxes can be transported and then separated, for example by lifting the back end of the set of nested drop boxes (FIG. 3) and allowing the inner drop box to slide out by the force of gravity, The inner drop box also can be forced out by a mechanical device, such as a hydraulic ram. After the inner drop box has been removed the front wall of the remaining drop box (or the next innermost drop box) can be replaced or folded back into a closed position.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A drop box comprising a back end wall that tapers in width from a first end to a second end coupled to a bottom wall that tapers in width from a first end to a second end.

2. The drop box according to claim 1 wherein the width of the back end wall adjacent to an open top portion is greater than the width of the back end wall adjacent to the bottom wall.

3. The drop box according to claim 2 further comprising a front end wall, wherein the width of the bottom wall adjacent to the front end wall is greater than the width of the bottom wall adjacent to the back end wall.

4. The drop box according to claim 1 having at least one side wall having at least one crease that extends along at least a substantial portion of a side wall dimension.

5. The drop box according to claim 1 further comprising a front end wall that is openable to facilitate loading or unloading of material.

6. The drop box according to claim 5 wherein the openable front end wall includes at least one door.

7. The drop box according to claim 6 wherein the door is coupled to the openable front end wall by a lever actuated assembly.

8. The drop box according to claim 5 wherein the openable front end wall includes plural doors.

9. The drop box according to claim 1 having a taper in a first direction and a taper second direction, the tapers in the first and second directions being sized and shaped to allow a first drop box to be nested with a second drop box.

10. The drop box according to claim 1 made from a material selected from metals, metal alloys, polymers, wood, and combinations thereof.

11. A drop box, comprising:
plural end panels that taper from a first end to a second end;
a side panel that includes at least one crease that extends along at least a substantial portion of a side panel dimension; and
a bottom panel that tapers from a first end to a second end, thereby defining a drop box having a first taper and a second taper.

12. The drop box according to claim 11 made from a material selected from metals, metal alloys, polymers, wood, and combinations thereof.

13. The drop box according to claim 11 made from an iron-based or aluminum-based metal alloy.

14. The drop box according to claim 11 made from a polymeric material.

15. The drop box according to claim 11 wherein at least one of the end panels is openable to facilitate loading or unloading of material.

16. The drop box according to claim 15 wherein the openable end panel includes at least one door.

17. The drop box according to claim 16 wherein the door is coupled to the openable end panel by a lever actuated assembly.

18. The drop box according to claim 15 wherein the openable end panel includes plural doors.

19. A combination of drop boxes, comprising:
a first drop box; and
at least a second drop box nested with the first drop box.

20. The combination according to claim 19 wherein at least one of the first and second drop boxes is tapered in two dimensions.

21. The combination according to claim 19 wherein both the first and second drop boxes are tapered in two dimensions.

22. The combination according to claim 19 wherein the first drop box is configured to be nested within the second drop box such that the first drop box extends through an open front end of the second drop box, the second drop box having a front end door configured to be secured in an open position.

23. The combination according to claim 22 wherein the front end door of the second drop box is configured to swing about 270° between a closed position and the open position.

24. A method for transporting drop boxes, comprising:
providing a first drop box that is tapered in at least two dimensions;
providing a second drop box that is tapered in at least two dimensions; and
nesting the first drop box with the second drop box to provide a nested combination for transport.
